(19) United States
(12) Patent Application Publication
(10) Pub. No.: US 2023/0179455 A1
(43) Pub. Date: Jun. 8, 2023

(54) MULTI-STAGE SEQUENTIAL PIM REDUCTION VIA SEQUENTIAL TRAINING

(71) Applicant: Meta Platforms, Inc., Menlo Park, CA (US)

(72) Inventors: Weizhong Chen, Georgetown, TX (US); Djordje Tujkovic, Los Altos, CA (US)

(21) Appl. No.: 18/059,632

(22) Filed: Nov. 29, 2022

Related U.S. Application Data
(60) Provisional application No. 63/286,907, filed on Dec. 7, 2021.

(51) Int. Cl. H04L 27/00

(52) U.S. Cl. CPC H04L 27/0008

(57) ABSTRACT

The disclosed computer-implemented method may include (1) determining a first stage estimated passive inter-modulation (PIM) noise using a nonlinear model, the nonlinear model receiving a nonlinear model input based on a transmitted signal, (2) training the nonlinear model using a training signal based on an uncorrected received signal, (3) determining an estimated PIM noise using the first stage estimated PIM noise and a finite impulse response (FIR) filter, (4) training the FIR using a second training signal based on the uncorrected received signal, and (5) subtracting the estimated PIM noise from the uncorrected received signal. Various other methods, systems, and devices are also disclosed.

### CROSS REFERENCE TO RELATED APPLICATION

This application claims the benefit of U.S. Provisional Patent Application No. 63/286,907, filed Dec. 7, 2021, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for passive inter-modulation (PIM) noise (“PIM noise”) reduction.

FIG. 2 is a chart that illustrates an approach to passive inter-modulation (PIM) noise reduction and/or cancellation.

FIG. 3 is a block diagram of an example system for multi-stage sequential PIM reduction via sequential training.

FIG. 4 is a block diagram of an additional example system for multi-stage sequential PIM reduction via sequential training.

FIG. 5 shows a flow diagram that illustrates a multiple stage and sequential training procedure in accordance with some embodiments described herein.

FIG. 6A shows an example schematic of a PIM estimator that may be used in a first stage of a PIM cancellation device.

FIG. 6B shows an example schematic of a calculator that may perform an efficient calculation of Ix′ that may be used in a first stage of a PIM cancellation device.

FIG. 7 shows a schematic of an example FIR filter that may be used in the second stage of a PIM cancellation device.

FIG. 8 shows a schematic representation of PIM generation by a nonlinear system and resulting frequency components.

FIG. 9 is a simplified schematic of PIM frequency components for a single antenna with a single-band transmitter.

FIG. 10 shows a schematic representation of a PIM model of noise components for single antenna and for two concurrent band transmission.

FIG. 11 shows an example timeline of training and inference in accordance with some embodiments described herein.

FIG. 12 is a block diagram of an example system for multi-stage sequential PIM reduction via sequential training.

FIG. 13 is a block diagram of an example implementation of a system for multi-stage sequential PIM reduction via sequential training.

FIG. 14 is a flow diagram of an example method for multi-stage sequential PIM reduction via sequential training.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

A mobile telephone base station may include a transmitter/receiver assembly. An uplink receiver may receive a “received signal” and a radio frequency (RF) downlink transmitter may transmit a “transmitted signal”. In some cases, the transmitted signal may introduce noise in the received signal. In particular, a transmitted signal on a nearby frequency may introduce passive inter-modulation (PIM) noise (or “PIM noise”) into the received signal.

PIM noise may arise in part due to nonlinearities in the RF transmitter that may lead to a signal frequency distribution of the transmitted signal extending out of a designated transmission band. PIM noise may also arise in part due to a duplexer used to couple the transmitter and the receiver.

Of particular concern, PIM noise included within an uncorrected received signal may reduce the receiver sensitivity and, in some cases, may block reception of data (e.g., uplink data) partially or entirely.

Hence, the present disclosure is generally directed to systems, methods, and apparatuses for passive inter-modulation cancellation (PIMC) to cancel or reduce PIM noise in a received signal. Examples include systems, methods, devices, and apparatuses configured to reduce or effectively eliminate PIM noise from the received signal.

An example approach may include multiple-stage sequential PIM cancellation using sequential training of a PIM estimator and a finite impulse response (FIR) filter. In some examples, a transmitted downlink signal may be used to estimate PIM noise in a received signal, and the estimated PIM noise may be subtracted from the received signal to produce a PIM-cancelled received signal. This approach may improve sensitivity of a receiver.

An example device, such as a multiple-stage sequential PIM cancellation device, may include a first stage and a second stage. The first stage may include a nonlinear filter that receives the transmitted signal as input and provides a first stage output. The nonlinear filter may use a trained model of PIM noise to estimate PIM noise. The second stage may include a linear FIR filter that receives the first stage output (e.g., the nonlinear filter output) of the first stage, and provides an estimated PIM noise as a second stage output. The estimated PIM noise may be an estimate of the PIM noise which is uncorrected with the desired received signal. The received signal may include the desired received signal and the PIM noise. The PIM cancelled signal (the PIMC result) may be obtained by subtracting the estimated PIM noise from the received signal (e.g., including a combination of the desired received signal and the actual PIM noise).

As will be described in greater detail below, the training of the PIM model used by first stage nonlinear filter and the training of the second stage linear FIR filter may be independent of each other and sequential. In some examples, the training is not a joint optimization. The first and second stages may be trained to reduce or minimize the error signal between the output and the received signal. The nonlinear filter may include both even order and odd order of the products of its input (the transmitted signal) regardless of the PIM structure. The linear FIR filter may be a 3-tap FIR filter, regardless of the PIM structure.

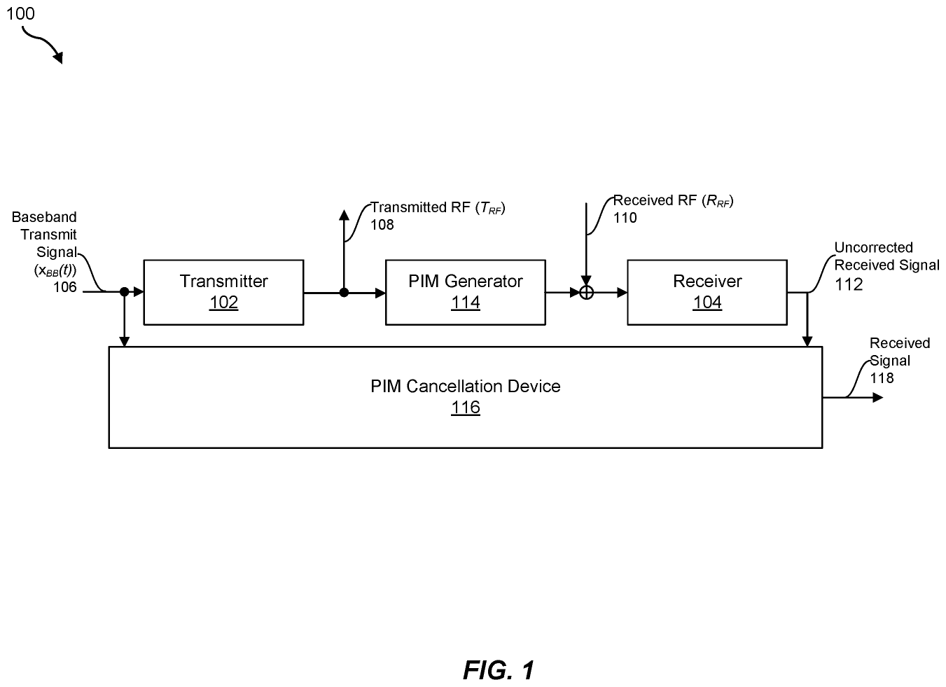

FIG. 1 shows a schematic of a system 100 according to some examples. As shown, system 100 may include a transmitter/receiver assembly, such as a mobile telephone base station transmitter and receiver (e.g., a 3rd Generation Partnership Project (3GPP) cellphone communication base station). System 100 may include a transmitter 102 (“BB Transmitter RF 102” in FIG. 1) and a receiver 104 (“RF Receiver BB 108” in FIG. 1). Transmitter 102 may receive a baseband transmit signal 106 (also denoted as x_{BB} or x_{BB}(t) herein) and transmit a transmitted RF signal 108 (also T_{RF} herein). Likewise, receiver 104 may receive an RF signal 110 (also R_{RF} herein) and may output an uncorrected received signal 112.

In some examples, a transmitter 102 and a receiver 104 may be co-located within the same base station. The transmitter 102 transmits signal T_{RF}, and the receiver 104 receives an uncorrected received signal R_{RF}. The transmitter 102 and the receiver 104 may operate in nearby channel frequencies (bands). This may not appear to be a problem if the transmission (TX) band and the reception (RX) band do not overlap. However, due to nonlinearities of the circuitry, the transmitted signal may produce nonlinear products (such as third or fifth harmonics). Transmitted frequency components may spread outside of the designated transmit band and some frequency components may spread into receive band and enter the uncorrected received signal as PIM noise. Noise generation may be represented in system 100 by PIM generator 114.

Hence, nonlinearities of the transmit circuit may create noise in the uncorrected received signal. In some examples, estimated PIM noise is determined by the PIM cancellation circuit, and the estimated PIM noise is subtracted from the uncorrected received signal to provide a PIM-cancelled received signal. In this figure, the PIM noise is subtracted after the RF receiver stage. If necessary, the RF receiver stage characteristics may be included in the model of the PIM noise.

The transmit signal 106 may be used to determine an estimated PIM noise. As further shown in FIG. 1, an example PIM cancellation device 116 may receive a signal based on the transmit signal 106 and may determine an estimate of PIM noise. The estimated PIM noise may then be subtracted from the combination of the uncorrected desired received signal and PIM signal in the receiver signal band to reduce the effect of PIM noise on the received signal. In this configuration, the combined receiver output may be referred to as the uncorrected received signal (e.g., uncorrected received signal 112) and may include a combination of the desired received signal and PIM noise. The term “uncorrected received signal” may refer to the signal from which estimated PIM noise is subtracted by the PIM cancellation device. The PIM noise may be reduced or substantially eliminated from the received signal by subtracting the estimated PIM noise from the uncorrected received signal, a process that may be termed PIM cancellation. The received signal output by the system after PIM cancellation, received signal 118 in FIG. 1, may have significantly reduced PIM noise. The PIM cancellation device may be a stand-alone unit or may be included as a component of the base station. In some examples, one or more operations of the PIM cancellation device may be performed in software by one or more suitably programmed software modules stored in memory and executed by at least one physical processor.

As shown in FIG. 1, transmitter 102 may include or receive a signal x_{BB}(t) (the baseband transmit signal 106) which may be encoded onto an RF carrier to form the transmitted RF signal 108 (T_{RF}). The PIM estimator input signal may be based on the baseband transmit signal 106. The transmitter may use digital predistortion (DPD) and crest factor reduction (CFR) within a power amplifier (PA). The baseband signal may be encoded as modulation of an RF carrier signal. The receiver may provide the uncorrected received signal as an uncorrected received baseband signal derived from the received RF signal 110 (R_{RF}), for example, by demodulation.

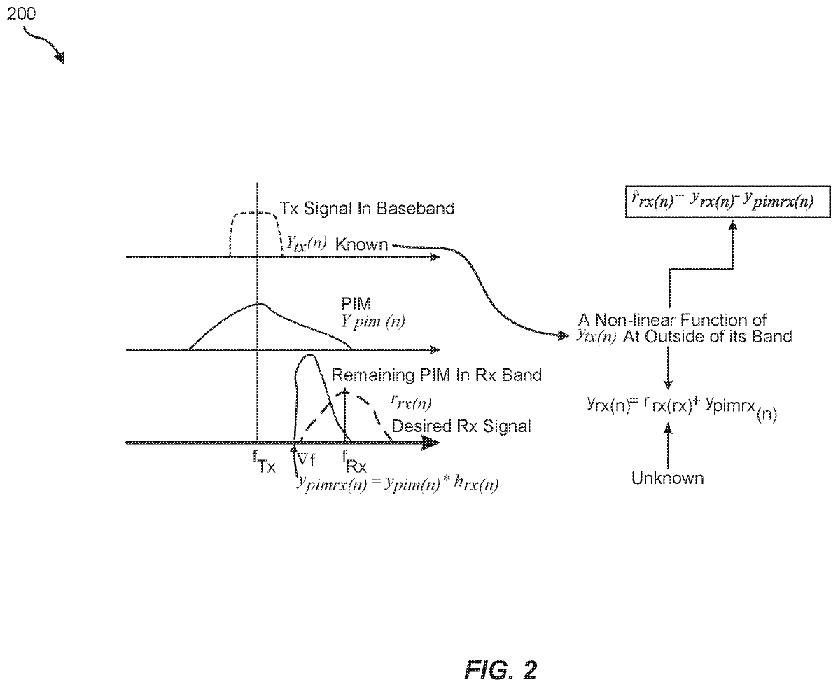

FIG. 2 shows a view 200 that illustrates an approach to PIM cancellation. The PIM signal may extend outside of the transmitted frequency band and may include frequency components (which may be termed PIM noise) that is within the receiver frequency band. A filter may be used to narrow the received frequencies to those frequencies with the receiver frequency band, but this approach will not remove the PIM noise that extends into the receiver band. Hence, an uncorrected received signal may include both the desired received signal and PIM noise.

The PIM noise may be a nonlinear function of the transmitted signal. The transmitted signal can be sampled and the nonlinear function can be modeled using a PIM estimator. Hence, the estimated PIM noise may be determined using a trained model and subtracted from the uncorrected received signal to leave the desired received signal.

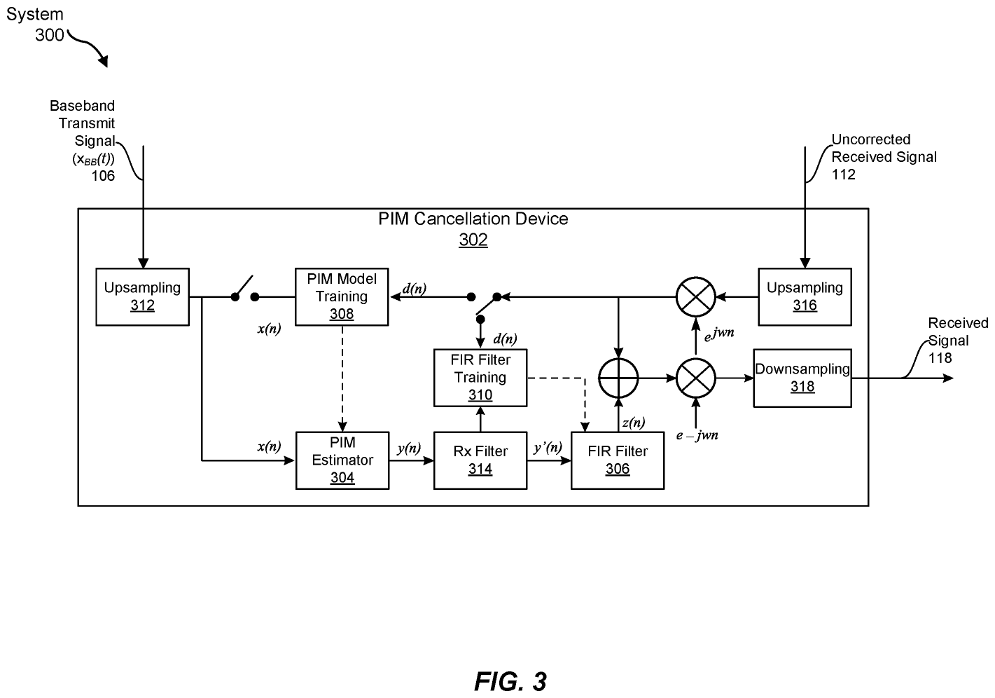

FIG. 3 shows an example device architecture 300 including a PIM cancellation device 302 that may be an implementation of the PIM cancellation device 116 shown in FIG. 1 above. As shown, PIM cancellation device 302 may include a PIM estimator 304, a FIR filter 306, a PIM model training module 308, and a FIR filter training module 310. Each of these elements will be described in greater detail below.

As shown in FIG. 3, PIM cancellation device 302 receives baseband transmit signal 106. The transmitted signal is sampled in any suitable way and may be, for example, upsampled at upsampling module 312. The transmit signal frequency and receive signal frequency may be at different frequency bands, and upsampling and downsampling may be used as needed to make sure the signals of interests are sampled with a frequency bandwidth that can cover their relative frequency difference.

The PIM cancellation device includes a PIM estimator 304 that provides an estimate of the PIM noise (e.g., using a PIM noise model), and this estimated noise may be filtered using Rx filter 314 and FIR filter 306. The PIM model and FIR filter may be trained using approaches described in more detail below. The first stage may include a PIM estimator having a nonlinear model. The PIM estimator input is based on the transmitted downlink signal. The PIM estimator output (e.g., of the nonlinear model) may provide an input for the second stage. The second stage includes a linear filter (e.g., Rx filter 314) and FIR filter 306. The system then subtracts the estimated PIM noise from the received signal to reduce the PIM noise in the received signal. The system may perform sequential training for the nonlinear model (e.g., at PIM model training module 308) and the FIR filter (e.g., not a joint optimization algorithm). An example nonlinear filter may include both the even order and the odd order products of its input (e.g., the transmitted signal), and the linear filter may be a 3-tap FIR filter. Here, x(n) may represent a PIM estimator input signal based on a sampled transmitter signal x_{BB}(t). Here, x(n) is filtered with a non-linear filter that produces the output y(n) of PIM estimator 304, where the non-linear filter coefficients are provided by PIM model training module 308 (stage 1 training). As shown, y(n) is then filtered (e.g., by Rx filter 314 and FIR filter 306) to provide an estimate of the PIM noise.

The PIM model trainer may receive signals based on the transmitted signals and based on the received signals, allowing a comparison of the estimated PIM noise and the actual PIM noise in the received signal. This allows training of the nonlinear model used by the PIM estimator. The receiver frequency band may be higher or lower than the transmitter frequency band, so the uncorrected received signals 112 may be upsampled (e.g., at upsampling module 316) to allow signal processing at the received frequency band. Likewise, the PIM-corrected signal may be downsampled to (e.g., at downsampling module 318) to produce received signal 118.

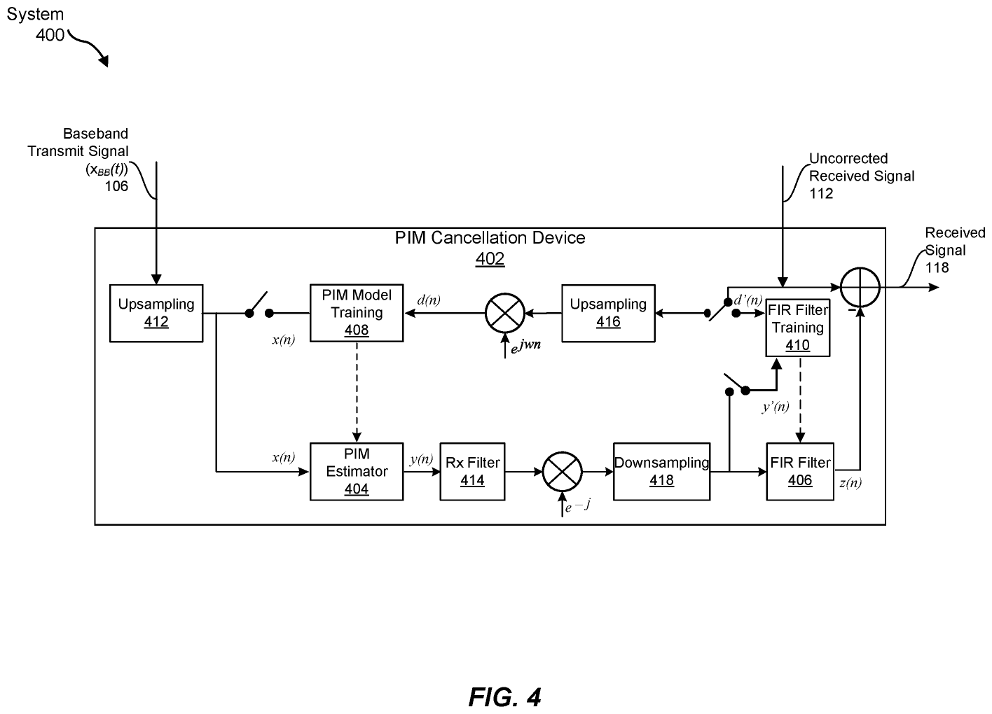

FIG. 4 shows an additional or alternative example device architecture 400. As shown, FIG. 4 includes a PIM cancellation device 402 having a PIM estimator 404, a FIR filter 406, a PIM model training module 408, and a FIR filter training module 410. FIG. 4 also includes upsampling module 412, Rx filter 414, upsampling module 416, and downsampling module 418. Each of these modules may perform similar functions to their counterparts in FIG. 3. However, this configuration may allow for a lower sampling rate than the configuration shown in FIG. 3. A PIM estimator input signal x(n) based on the transmitted signal and a training signal d(n) based on the uncorrected received signal are collected.

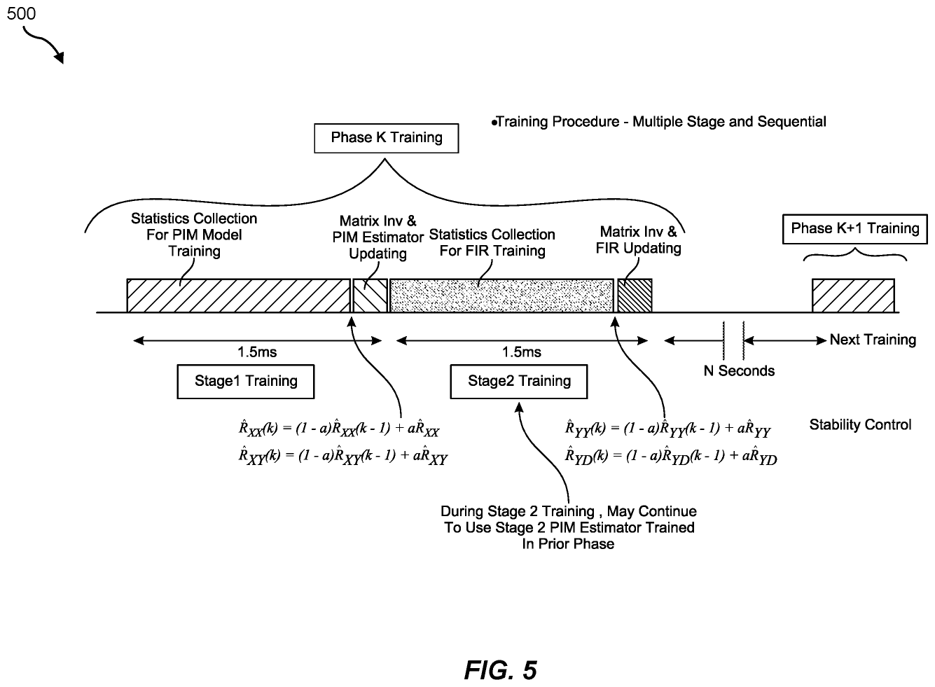

FIG. 5 shows a flow diagram 500 that illustrates a multiple stage and sequential training procedure. As shown in FIG. 5, during the first 1.5 ms of a phase of training (e.g., Phase K Training), stage 1 training takes place; stage 2 training takes place in the next 1.5 ms.

To reduce training operations for power reduction, the training may be operated periodically, for example, once every minute or other time interval (e.g., between 20 seconds and 5 minutes), within which a small window (e.g., between 0.5 ms and 20 ms, such as 3 ms) is open for the PIM model training to operate, as shown in FIG. 5. The PIM model training may be sleeping over the rest of the period (e.g., one minute or other time interval). Within the training window, the PIM model training collects and/or accumulates statistics, and at end of the accumulation the PIM model training module (e.g., PIM model training module 308, PIM model training module 408, etc.) may calculate the PIM model coefficients and provide them to the PIM Estimator.

Stage 1 training and stage 2 training can take place in sequential order, and they do not have to be strictly connected in time, and a certain time gap (e.g., 0.25 ms) between them is allowed. In addition, the stage 1 training and stage 2 training are decoupled, meaning their training does not require a joint optimization. Instead, the optimizations of stage 1 training and stage 2 training may be independent. The dependence between them is only the output of the stage 1 is used before training stage 2 takes place. Hence, the training of the stages is sequential, and the stages are independent of one another. This means the output of the stage 1, as shown in FIG. 3, is filtered with the receiver filter (e.g., Rx filter 314) and the output of the receiver filter is used as the input to the stage 2 training performed by FIR filter training module 310. In summary, the two training stages happen sequentially and within a same training window (e.g., a training window of 3 ms).

The PIM training model may be expressed mathematically as represented below by Eq. (1):

$$\begin{matrix}{y}_{GMP} ( n ) = {\sum }_{k = 1}^{{K}_{a} - 1} {\sum }_{l = 0}^{{L}_{a} - 1} {a}_{kl} x ( n - l ) {\vert x ( n - l ) \vert}^{k} \\ + {\sum }_{k = 1}^{{K}_{b} - 1} {\sum }_{l = 0}^{{L}_{b} - 1} {\sum }_{m = 1}^{{M}_{b} - 1} {b}_{klm} x ( n - l ) {\vert x ( n - l - m ) \vert}^{k} \\ + {\sum }_{k = 1}^{{K}_{c} - 1} {\sum }_{l = 0}^{{L}_{c} - 1} {\sum }_{m = 1}^{{M}_{c} - 1} {c}_{klm} x ( n - l ) {\vert x ( n - l + m ) \vert}^{k}\end{matrix} \qquad ( 1 )$$

The first portion in the model may be referred to as “aligned” terms of the PIM, the second portion in the model may be referred to as “lead teams” of the PIM, and the third portion in the model may be referred to as “lag terms” of the PIM.

For convenience, only aligned terms are described here, but lead terms and/or lag terms may also be used in actual implementation.

An example stage 1 PIM estimation with aligned PIM terms may use Eq. (2) below:

y(n)=c₁x(n)|x(n)|+c₂x(n)|x(n)|²+c₃x(n)|x(n)|³+c₄x(n)|x(n)|⁴+c₅x(n)|x(n)|⁵ (2)

The PIM model of the aligned terms in stage 1 training may use both odd orders and even orders, regardless of whether the actual PIM signal has only odd terms or has both odd and even terms.

In Eq. (2) above, |x(n)| in the stage 1 PIM model training may be calculated with a low-cost algorithm based on the following equation, where Max and Min are the maximum or minimum of the magnitudes of the real part and imaginary part respectively. For example, a relationship of the form |x(n)|=Max(I,Q)+0.5Min(I, Q) where {c1, c2, c3, c4, c5} represent model coefficients that may be updated periodically (e.g., in seconds or minutes) from training.

The second stage of PIM noise estimation may include a 3-tap FIR filter, where z(n) is the estimated PIM noise, for example, as given by Eq. (3) below:

z(n)=h₁y′⁽ⁿ⁻¹⁾+h₀y′⁽ⁿ⁾+h₋₁y′⁽ⁿ⁺¹⁾ (3)

PIM cancellation to obtain a corrected received signal (x′) may be achieved by subtracting the estimated PIM noise (z) from the uncorrected detector signal (d), for example, as shown below in Eq. (4):

x′⁽ⁿ⁾=d(n)−z(n) (4)

An example PIM estimator may be trained using an approach such as described below. Eq. (5) describes relationships that may be used to train the PIM estimator:

\hat{x}₁=x(n)|x(n)|,\hat{x}₂=x(n)|x(n)|²,\hat{x}₃=x(n)|x(n)|³,\hat{x}₄=x(n)|x(n)|⁴,\hat{x}₅=x(n)|x(n)|⁵ (5)

Here, |x| in the example PIM Estimator may be calculated in accordance with an enhanced accuracy algorithm. Training may be for a relatively short period (e.g., approximately equal to or less than 50 ms, such as approximately equal to or less than 20 ms, for example approximately equal to or less than 10 ms, and so forth). An example algorithm may be based on Eq. (6) through Eq. (8) below, though these represent example approaches and other approaches may be used:

$$\vert x \vert = max ( \vert {x}_{0} \vert , \vert {x}_{1} \vert ) \qquad ( 6 )$$

$$\vert {x}_{0} \vert = max ( I , Q ) + \frac{1}{8} min ( I , Q ) \qquad ( 7 )$$

$$\vert {x}_{1} \vert = \frac{7}{8} max ( I , Q ) + \frac{33}{64} min ( I , Q ) \qquad ( 8 )$$

Let a block of inputs be represented by:

$$X = [ \begin{matrix}{\hat{x}}_{1} ( n ) & {\hat{x}}_{2} ( n ) & {\hat{x}}_{3} ( n ) & {\hat{x}}_{4} ( n ) & {\hat{x}}_{5} ( n ) \\ {\hat{x}}_{1} ( n + 1 ) & {\hat{x}}_{2} ( n + 1 ) & {\hat{x}}_{3} ( n + 1 ) & {\hat{x}}_{4} ( n + 1 ) & {\hat{x}}_{5} ( n + 1 ) \\ ⋮ & ⋮ & ⋮ & ⋮ & ⋮ \\ {\hat{x}}_{1} ( n + N ) & {\hat{x}}_{2} ( n + N ) & {\hat{x}}_{3} ( n + N ) & {\hat{x}}_{4} ( n + N ) & {\hat{x}}_{5} ( n + N )\end{matrix} ] , \qquad ( 9 )$$

$$Y = [ \begin{matrix}d ( n ) \\ d ( n + 1 ) \\ d ( n + N )\end{matrix} ]$$

The terms used in Eq. (9) may relate to values of various signals that are shown and discussed above in relation to FIG. 3.

A block level autocorrelation and cross-correlation may then be calculated in accordance with:

R_{XX}=X^{H}X,R_{XY}=X^{H}Y (10)

Data may be accumulated over K blocks (e.g., covering about 1 ms), such that:

\hat{R}_{XX}=\hat{R}_{XX}+R_{XX},\hat{R}_{XY}+R_{XY} (11)

Updated PIMC coefficients may then be calculated using the relationship of Equation 12 below:

C=(\hat{R}_{XX})⁻¹\hat{R}_{XY} (12)

The second stage may be trained using the following illustrative approach. To reduce memory, the statistics may be accumulated over small blocks, where the block size can be as small as one sample.

In Equation 13 below, a block of input may be denoted as y′(n) and the desired output data may be denoted d(n)

$${Y}^{′} = [ \begin{matrix}{y}^{′ ( n - 1 )} & {y}^{′ ( n )} & {y}^{′ ( n + 1 )} \\ {y}^{′ ( n )} & {y}^{′ ( n + 1 )} & {y}^{′ ( n + 2 )} \\ ⋮ & ⋮ & ⋮ \\ {y}^{′ ( n + N - 1 )} & {y}^{′ ( n + N )} & {y}^{′ ( n + N + 1 )}\end{matrix} ] , D = [ \begin{matrix}d ( n ) \\ d ( n + 1 ) \\ d ( n + N )\end{matrix} ] \qquad ( 13 )$$

The block level autocorrelation and cross-correlation may then be calculated:

R_{Y′Y′}=Y′^{H}Y′,R_{Y′D}=Y′^{H}D (14)

Accumulation across blocks may lead to the following:

\hat{R}_{Y′Y′}=\hat{R}_{Y′Y′}+R_{Y′Y′},\hat{R}_{Y′D}=\hat{R}_{Y′D}+R_{Y′D} (15)

The second stage PIM estimation may be determined using a 3-tap FIR filter:

H=(\hat{R}_{Y′Y′})⁻¹\hat{R}_{Y′D} (16)

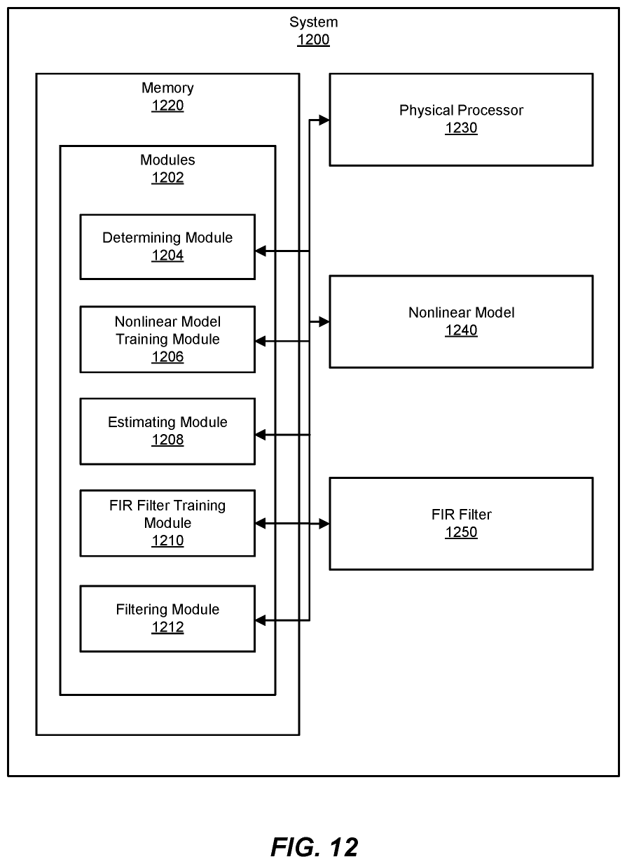

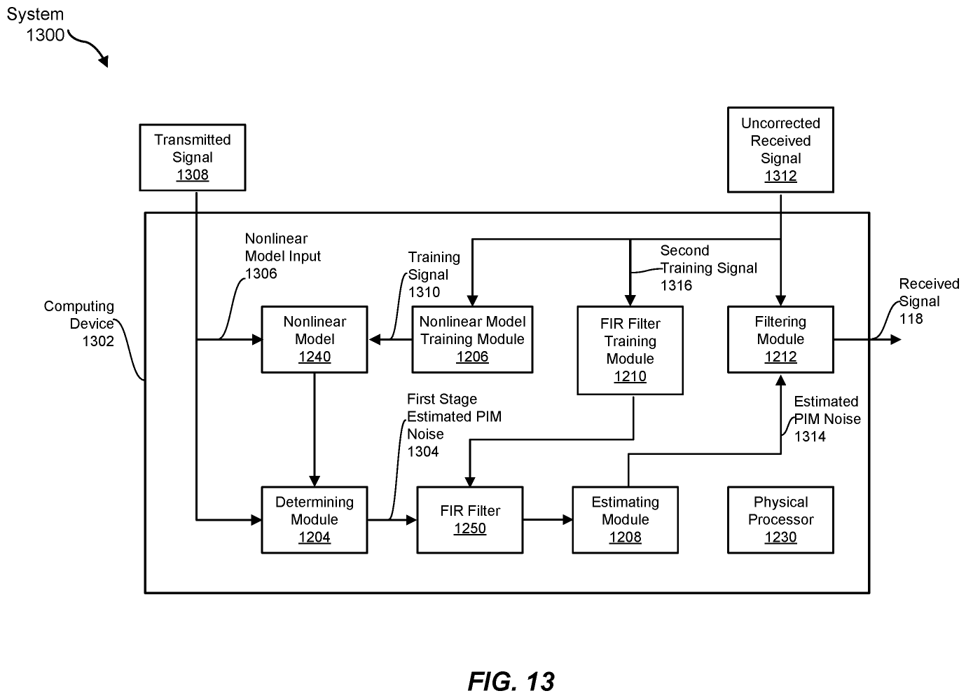

FIG. 5 shows a timeline of an example of multiple stage sequential training approach. An example PIM cancellation device (e.g., as discussed above in relation to FIGS. 1, 3, and 4, and as described below in relation to FIGS. 12 and 13) may use the PIM estimator (e.g., using an input signal based on the transmitted signal) to determine an estimated PIM noise. The estimated PIM noise may be subtracted from the uncorrected received signal to provide a corrected received signal. The PIM cancellation device may use a training signal based on the uncorrected received signal to train a PIM estimator. During a training period, the training signal may be used to obtain improved model parameters for the PIM estimator (e.g., by comparing the PIM estimator input signal with the training signal using the PIM model trainer).

Multiple stage training may include collecting data (statistics) for the PIM model training during a first period, updating the model parameters of the PIM model, and then collecting data (statistics) for FIR training, and then updating the FIR. The model used by the PIM estimator and the model used by the FIR may be updated sequentially. During data collection periods, the previous model parameters may be used to provide a PIM noise estimate.

A remarkable aspect of some examples may be that the PIM estimator may continue to determine an estimated PIM noise during one or both training periods, so that the received signal may continue to be PIM-cancelled during one or both training periods. For example, stage 1 and/or stage 2, such as the FIR, may be used with the current parameters while data from which updated parameters are determined are collected during a training period.

After the PIM estimator training period is completed, the model parameters of the PIM estimator may be updated using updated model parameters from the PIM model trainer. In some examples, the model parameters of the PIM estimator may be replaced by new model parameters from the PIM model trainer.

In some examples, model parameters may be replaced by new model parameters that include a combination of the previously used model parameters and the updated model parameters from the PIM model trainer. For example, a new model parameter may include an X % contribution from the currently used model parameter and a Y % contribution from the updated model parameter from the PIM model trainer. In some examples, Y=100−X. In some examples, Y % (the contribution from an updated parameter to a new model parameter) may be between 40% and 100%, such as between 60% and 95%. In some examples, X % (the contribution from the current parameter to a new model parameter) may be between 0% and 60%, such as between 5% and 40%, and in some examples may be approximately 10%. In some examples, the new model parameter may include a contribution (e.g., Z %) from one or more other previously used model parameters and/or other stored model parameter values. The use of model parameters based on a combination of new model parameters and previously used model parameters may provide stabilization of the model performance and may reduce the effects of transient problems (e.g., noise glitches or electrical instabilities) on the model parameters. In some examples, a change in a particular model parameter may be restricted to a value up to a predetermined threshold, such as 5%, for each particular update of the model parameters.

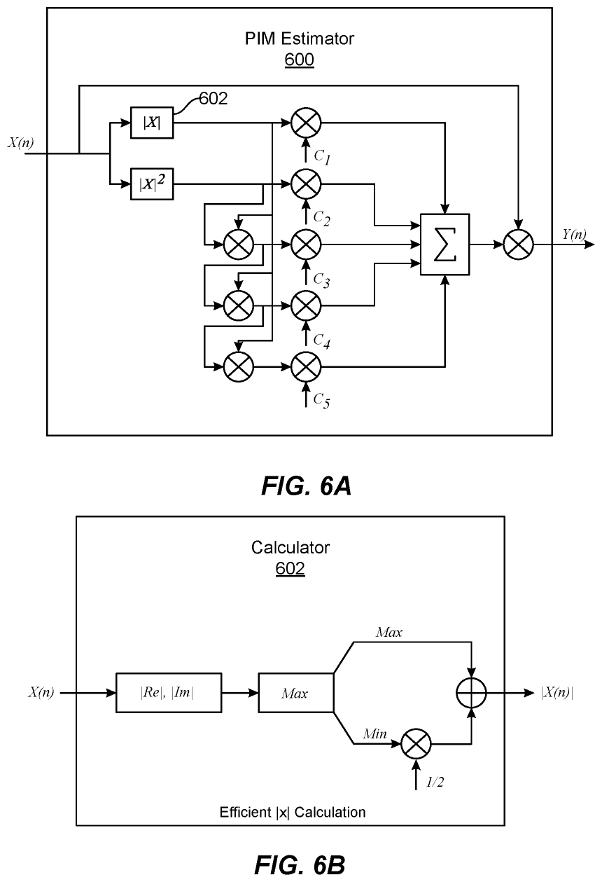

FIG. 6A shows an example schematic of a PIM estimator 600 that may be used, for example, in the first stage of a PIM cancellation device (e.g., as part of an implementation of PIM estimator 304 in FIG. 3, PIM estimator 404 in FIG. 4, etc.). As shown, PIM estimator 600 may receive an X(n) signal as described herein (e.g., in reference to FIG. 4) and may output a Y(n) signal as described herein (e.g., in reference to FIG. 4). PIM estimator 600 may include a calculator 602 that may perform an efficient calculation for Ix′ as shown in FIG. 6B.

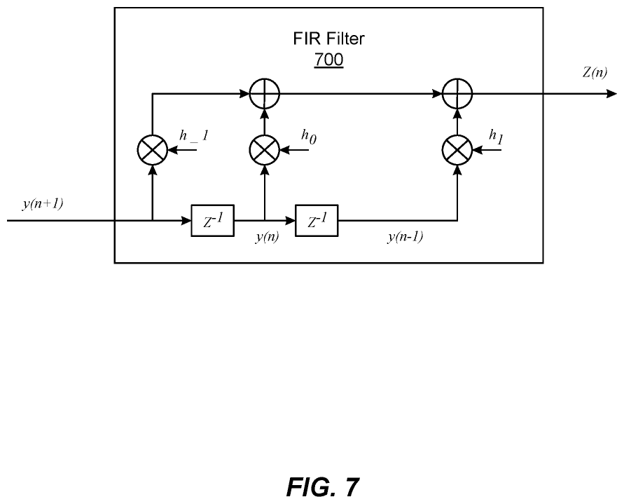

FIG. 7 shows a schematic of an example FIR filter 700, which may be used in the second stage of a PIM cancellation device (e.g., as part of FIR filter 306 in FIG. 3, as part of FIR filter 406 in FIG. 4, etc.). As shown, FIR filter 700 may receive a y(n+1) signal and may output a Z(n) signal (e.g., as shown in FIG. 3 and/or FIG. 4).

Both active and passive components within a circuit may introduce nonlinear effects, and both may impact system performance. Passive intermodulation (e.g., PIM) may include one or more intermodulation products generated when two or more signals transit through a passive device with nonlinear properties. Nonlinear elements may arise from the interaction of mechanical components, such as the junction of two different metals, loose cables connections, dirty connectors, poor duplexers, aged antennas, and the like. The transmitted signal may generate PIM signal components in the receiver frequency band and these signals may be received as interference, may reduce the receiver sensitivity, and in some circumstances may prevent the receiver from detecting a real signal.

PIM signal components may occur at sum and difference frequencies of two carrier frequencies and their harmonics. For example, if the carrier frequencies are denoted f1 and f2, then PIM components f_{PIM(n+m)} may occur at frequencies nf₁−mf₂ and/or nf₂−mf₁, where n and m are integers and may be the same or different. The sum (m+n) may be called the PIM product order.

PIM can also occur at multiples of the carrier frequencies (e.g., as even order PIM). When these frequencies are far away the transmit carrier frequency, they may be disregarded for paired FDD transmit and receive, as typically the receiver frequency is not that far from the transmit frequency band.

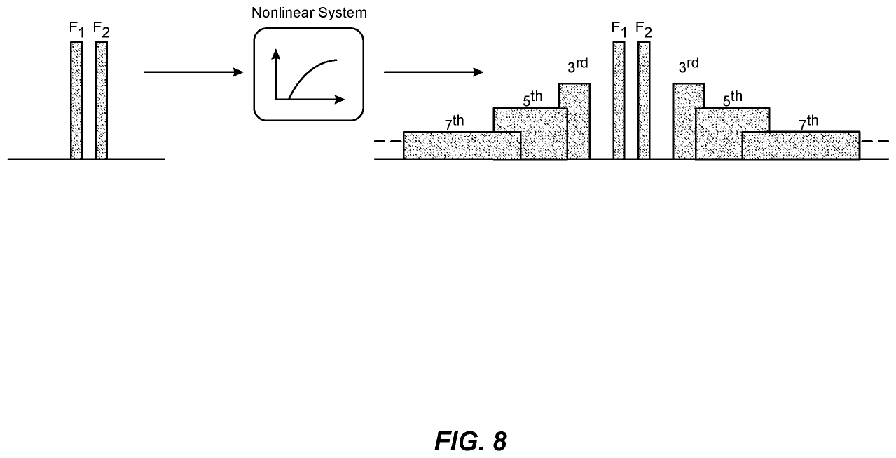

FIG. 8 shows a schematic representation of PIM generation by a nonlinear system and resulting frequency components.

Some representative numerical examples are now considered, but these are provided only by way of example and not by way of limitation. For example, assume transmitting two tones or two carriers at f₁=1940 MHz and f₂=1980 MHz, having a 40 MHz spacing. In this example, the third order PIM may occur at frequencies such as 2f₁−f₂ and 2f₂. Numerically, 2f₁−f₂=2×1940−1980=1940−(1980−1940)=(1940−40)MHz, and the third order PIM may occur at a frequency 40 MHz lower than f₁. Third order PIM may also occur at 2f₂−f₁=2×1980−1940=1980+(1980−194)=1980+40 MHz, or 40 MHz higher than f₂. Similarly, the 5th order PIM (IM5) may occur at frequencies such as 3f₁−2f₂ or 3f₂−2f₁. The first of these occurs at 3f₁−2f₂=1940−2×(f₂−f₁)=(1940−2×40)MHz, or at a frequency 80 MHz lower than f₁. The second occurs at 3f₂−2f₁=f₂+2×(f₂−f₁)=(1980+2×40)MHz, or at a frequency 80 MHz lower than f₂. There may also be higher order components such as 7th order, 9th order, or higher orders.

As the magnitude of these PIM frequency components decreases as the order increases, it may be tempting to disregard these higher order components. However, the signals in the transmit band may have more than a single tone and may be very rich in frequency components. Some or all of the various frequency components may inter-modulate with each other, and the resulting PIM spectrum may be very complicated in frequency components and magnitude.

PIM may arise from any nonlinear junction or other nonlinear circuit component and may result from distortion due to any nonlinear current-voltage behavior. Some common origins of nonlinear behavior are now discussed. Metal-metal contact surfaces separated by a thin oxide may exhibit metal-insulator-metal (MIM) diode-like conduction properties. Rough metal-metal contact surfaces may cause current crowding at spots where conduction is both resistive and capacitive. A circuit may include a nonlinear material and/or an impure material. In some examples, the source of the nonlinearity may be randomly distributed over the transmission path and its environment

PIM generation may also be time-dependent, for reasons now discussed. A nonlinear behavior may change over time due to changes in ambient conditions, such as temperature, moisture, the presence of one or more birds or other lifeforms on the transmission line or antenna panel, or other condition. Different PIM measurements may show big differences, even for the same circuit or component thereof. Hence, dynamic updating of model parameters, for example, by model training at intervals, may be useful.

PIM may result between two carrier frequencies but is not limited to the case of only two carrier frequencies. In a base-station where multi-carrier and multi-band are used, many transmitted signals may be mixed with each other, and PIM distortion may spread over a wide range of the spectrum and may reach one or more receiver frequency bands.

PIM distortion may result from internal transmitted signals, and may also result from the external transmitted signals from the neighbor cells. The latter may act as a PIM source and create interference in one or more receiver bands.

PIM distortion may sometimes be reduced by good system layout and precise mechanical dimensions, regular system maintenance such as inspection and cleaning (e.g., of electrical contacts). However, manual maintenance may be inconvenient and/or expensive, and may require the system to be unpowered.

Digital adaptive distortion suppression methods may provide an effective and less expensive solution. An adaptive filter may be used estimate PIM and subtract the estimated PIM distortion from the received signal. Frequency planning may be used to avoid PIM noise falling into a receiver band. However, as the spectrum becomes crowded, frequency planning alone may be insufficient to remove PIM noise and adaptive distortion suppression approaches, such as described herein, may be used.

PIM may be significant when the transmission path is shared with receiving path and the PIM noise falls within a received signal band and impacts receiver sensitivity. PIM effects may be reduced if the receiving signal path is different from the transmission signal path. Conductive PIM that occurs within a physical transmission line may not be an issue. However, PIM generated over the transmission line may also leak back into the receiver path via radiative effects. This source of PIM may be termed radiative PIM, and may have a greater time delay than conductive PIM.

A radiated electromagnetic signal (e.g., from at least a portion of the transmission path) may stimulate nearby objects (e.g., electrically conductive objects) that may also generate PIM noise signals that may leak into the receiver path. This may also have a greater time delay than conductive PIM.

In some examples, an adaptive PIM cancellation approach may be adapted for use with a single antenna. However, examples also include analogous PIM cancellation approaches configured for multiple-antenna systems. For multiple antenna transmission, the PIM due to one antenna may leak into neighboring antennas, and a more complicated adaptive PIM cancellation algorithm may be used. For massive multiple-input and multiple-output (mMIMO) systems with massive antenna transmission, the complexity of an adaptive PIM cancellation algorithm may become prohibitively complicated (e.g., using hundreds of millions of gates and requiring complex processing systems and relatively high power consumption). However, in some examples described herein, a relatively low complexity PIMC algorithm such as those described herein may be used for mMIMO systems, allowing relatively low cost, light weight, and low power applications.

For time division duplex (TDD), PIM may be relatively unimportant, as there may be no transmission during the receiving time window and/or no reception during the transmission time window. PIMC may be particularly useful for frequency division duplex (FDD) and other protocols where transmission and receiving share the time window.

An antenna assembly (e.g., of a cellphone tower) may include several sets of antennas with different transmission bands, and sometimes may be shared with different operators. The transmission of different operators that are not collaborating to avoid PIM may, in the absence of PIMC, may require stringent isolation requirements and higher cost and/or weight design. The use of PIMC, for example, using an approach described herein, may greatly reduce the cost and/or weight requirements of an antenna assembly.

In multiband operation with mixed FDD and TDD transmissions, a TDD receiver may also suffer from PIM due to radiative PIM (e.g., from a first antenna transmitting during the reception window of a second antenna).

Hence, improved PIMC approaches may be useful for numerous applications.

In some examples, an adaptive PIMC algorithm may use a transmitted signal (e.g., a representation of a known transmitted signal or an estimate of a transmitted signal) to determine an estimated PIM signal in the receiver band and to subtracted the estimated PIM signal from the received signal.

Even if the transmitted signals are known, as the number of transmitted signals increase, the PIMC algorithm complexity may grow exponentially with the number of transmitted signals and transmitted antenna ports. The complexity of a PIMC algorithm may also grow with the physical distance between the PIM source and the receiver signal path. This is because more taps in the PIMC algorithm, more coefficients to be trained and tracked and more computation in PIM estimation in each step of cancellation, which is at high sampling rate.

An antenna may use a single wideband transmission which has rich frequency components within its band and may generate passive inter modulation products. A similar approach may be applied to a combination of multiple concurrent band transmissions if the multiple concurrent bands are collectively considered as a single band. In some examples, higher order PIM components and/or transmission frequency harmonics may be neglected as normally too far from the transmission band. However, some transmission protocols (e.g., 5G) may extend from 700 MHz to 6 GHz or even 7 GHz, and higher order components may be considered in PIMC approaches.

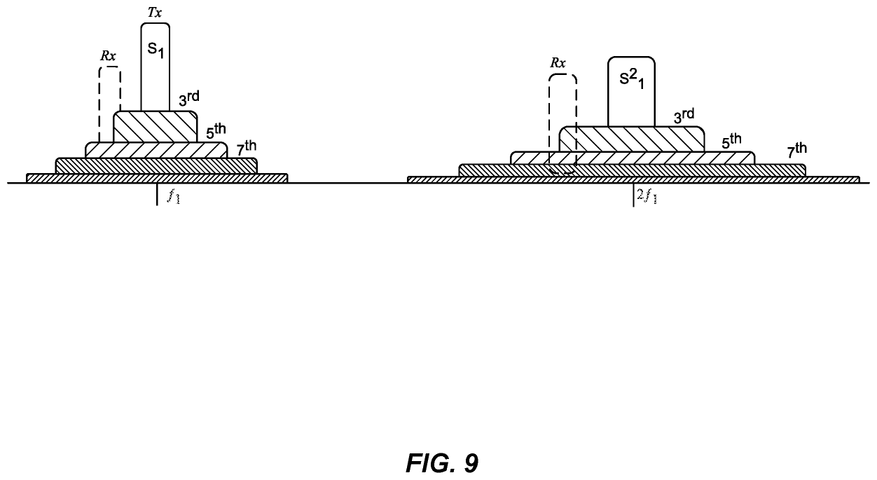

FIG. 9 is a simplified schematic of PIM frequency components for a single antenna with a single-band transmitter and shows PIM components around the frequency f₁, and higher frequency PIM components around a frequency 2f₁. The higher frequency components may spread over double the frequency range (compared to those centered on f₁) as the source signal is S₁² at a frequency 2f₁. The input to a PIM estimator may include this S₁² term as an alternative to or in addition to noise components around f₁ (e.g., depending on the location of the reception band).

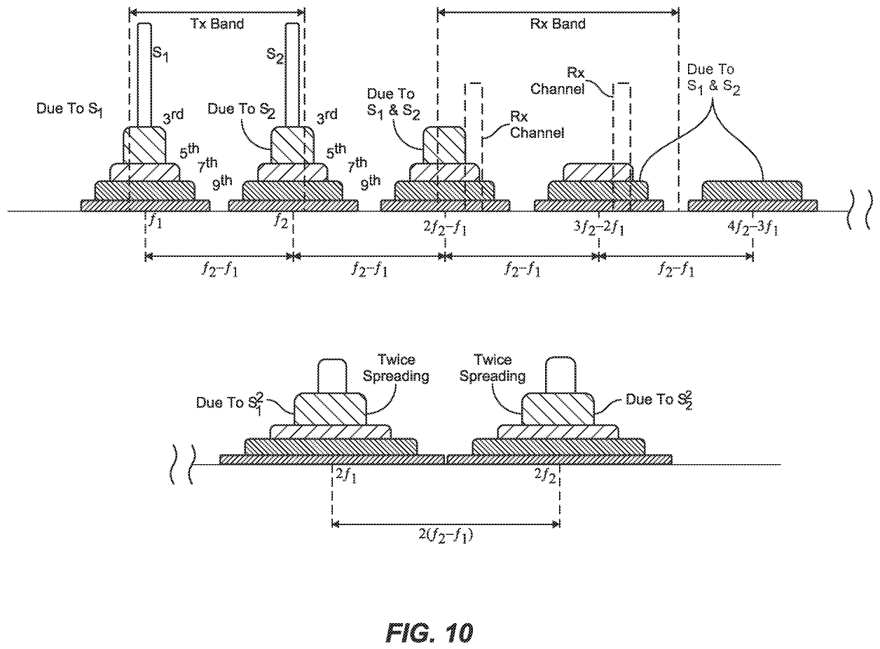

FIG. 10 shows a schematic representation of a PIM model of noise components for single antenna and for two concurrent band transmission. The higher frequency components, around 2(f₂−f₁) may be considered if these interfere with a reception band, which may occur, for example, for 5G and sub-6G spectra of 700 MHz to 6 GHz or 7 GHz. In some examples, such as where multiple operators share cell sites and/or share BTS equipment, it may be useful to include these higher frequency components.

Further details of model approaches and examples of model performance improvement and PIM noise reduction due to the PIMC approaches are now described.

The PIM source model may have the form given in Equation 17 below:

$$\begin{matrix}{y}_{GMP} ( n ) = {\sum }_{k = 1}^{{K}_{a} - 1} {\sum }_{l = 0}^{{L}_{a} - 1} {a}_{kl} x ( n - l ) {\vert x ( n - l ) \vert}^{k} \\ + {\sum }_{k = 1}^{{K}_{b} - 1} {\sum }_{l = 0}^{{L}_{b} - 1} {\sum }_{m = 1}^{{M}_{b} - 1} {b}_{klm} x ( n - l ) {\vert x ( n - l - m ) \vert}^{k} \\ + {\sum }_{k = 1}^{{K}_{c} - 1} {\sum }_{l = 0}^{{L}_{c} - 1} {\sum }_{m = 1}^{{M}_{c} - 1} {c}_{klm} x ( n - l ) {\vert x ( n - l + m ) \vert}^{k}\end{matrix} \qquad ( 17 )$$

Here, k represents even integers used (e.g., k may have values up to 8, so that k may be 2, 4, 6, or 8, so that the number of k values (k index) may be 4. In some examples, the term l may be 0, 1, 2, 3, 4, or 5 so that the number of 1 values (l index) may be 6. In some examples, m may be 1, 2, 3, 4, or 5 so that the number of m values (the m index) may be 5. The numbers (indices) of k, l, m terms influence the PIM source complexity.

The first portion on the right-hand side of Equation 17 may be referred to as containing aligned terms, and the second and third terms on the right hand side of Equation 17 may be referred to as containing leading and lagging terms.

In some examples, such as for a 3GPP fifth-generation new radio (5G NR) base station operated below 6 GHz (normally called sub-6G), significant PIM noise reduction may be obtained. The terms aₖₗ may be generated by the following approach. Assume aₖₗ=ak×al, and both ak and al are independent Gaussian in dB. However, the power of ak and al is exponentially attenuated as k or l increases. The terms bₖₗₘ may be generated using the following approach. Assume bₖₗₙ=bk×bl×bm and bk, bl, bm are independent Gaussian in dB. However, the power of bk, bl, and bm are exponentially attenuated as k, l, or m increases. The terms cₖₗₘ may be generated using the following approach. Assume cₖₗₘ=ck×a×cm and ck, cl, and cm are independent Gaussian in dB. However, the power of ck, cl, and cm are exponentially attenuated as k, 1, or m increases. The attenuation speed may also influence the PIM source complexity.

A PIM source model was adopted using the approach described above. In an example representative approach (not limiting), the following parameters may be adopted. For signal power settings: input signal average power is set to be −12 dB for a peak envelope less than 1; aligned PIM average power is set to be 10 dB below input signal average power; lag PIM average power is set to be 10 dB below Input signal average power; and led PIM average power is set to be 10 dB below Input signal average power. For aligned PIM generation: lₐ=[0,1,2,3,4,5]; kₐ=[2,4,6,8], with % up to 9th order PIM; AttendB was set to −15, the % attenuation from 0 dB to AttendB over the span of lₐ and kₐ; RanddB=4, the % standard deviation of a Gaussian in dB with variation on top of attenuation. For lag PIM generation: l_{b}=[0,1,2,3,4,5]; k_{b}=[2,4,6,8]; m_{b}=[1,2,3,4,5]; AttendB=−15, the % attenuation from 0 dB to AttendB over the span of lb, m_{b} and k_{b}; and RanddB=4, % standard deviation of Gaussian in dB, on top of attenuation. For Led PIM generation: l_{c}=[0,1,2,3,4,5]; k_{c}=[2,4,6,8]; m_{c}=[1,2,3,4,5]; AttendB=−15, the % attenuation from 0 dB to AttendB over the span of l_{c}, m_{c} and k_{c}; and RanddB=4, % standard deviation of Gaussian in Db, on top of attenuation.

For initial evaluation, only aligned terms of PIM were used for PIM cancellation. The training model only covered the aligned terms and used the same location of aligned terms as in the PIM model. This may correspond to only using the first term on the right-hand side of Equation 17. However, the second and third terms in the right-hand side of Equation 17 (leading and lagging terms) may be included in the model, and similar behavior of the index terms may be assumed.

In some experiments, PIMC performance was evaluated using various test setups, such as the following. In a representative configuration, between 1 and 16 PIMC l-taps and 3 FIR taps were used, with PIM generation setting set at between 0 and 3 and a SPR (signal-to-PIM ratio)=−20:5:20 dB.

The following conclusions were drawn. PIMC without FIR can eliminate between 3 dB and 10 dB of PIM noise. This may be considered a form of single stage PIMC using a PIM estimator model, for example, as described above. However, PIMC with FIR can eliminate between 13 dB and 15 dB of PIM noise. This remarkable reduction in noise shows the value of multi-stage PIMC.

The performance of single-stage PIMC (without an FIR) may be further improved using additional l-taps. However, PIMC with FIR does not require as many l-taps, and showed limited additional gain when increasing the number of l-taps beyond 4 l-taps.

Surprisingly, the PIMC gain does not appreciably increase with SPR (signal-to-PIM ratio). The window may be long enough that the uplink signal effect is removed.

A representative example of PIMC included error vector magnitude (EVM) analysis of PIMC versus SPR. Before PIMC, P_{PIM}=Pᵤₗ or SPR may be set to 0 dB (e.g., as a reference value for the uncorrected received signal). However, after PIMC, SPR=−16 dB, there is no change to Pᵤₗ, and the PIM noise is suppressed by 16 dB with between 1 and 15 PIMC l-taps and 3 taps with the FIR.

Different example representative settings were also investigated. An example approach to PIMC used l-taps at: (0, 1, 2, 3, . . . , 14, 15) and k-taps: 2,4,6,8. To improve performance, more PIMC l-taps may be used. FIR systematically gives 10 dB better performance. However, FIR may not reduce the usefulness of increased the l-taps.

Experiments were also performed to determine the effect of training window size. PIM model training window size and/or FIR training window size may be adjusted.

In some examples, a fixed FIR training window was set at 3×30720 samples or 1 ms. Excellent results were obtained with a PIM model training window of 1.5 subframes for statistics collection, plus 0.5 ms for matrix inversion, and with a varying PIM model training window length.

A counter-intuitive observation based on observed results was that, when varying PIM model training window size, there was little performance impact without FIR, and significant impact (improvement) with a FIR that has fixed window size. A small PIM model training window may cause effects in the model that FIR cannot account for.

In further experiments, the PIMC model training window was fixed at 1.5 ms, and the FIR training window size was varied, with two non-overlapping training windows. Significant improvements were obtained using an FIR training window including a 1 ms statistics collection time period with an additional 0.25 ms time period for matrix inversion. Improvements were seen in representative results, for l-taps at: (0,1,2,3,4,5) and k-taps at: 2, 4, 6, 8.

Significant PIM noise reduction may be obtained using a PIM model training window including 1.5 ms for statistics collection and 0.5 ms for matrix inversion, along with an FIR training widow including 1 ms statistics collection and 0.25 ms matrix inversion. In some examples, these time periods may be non-overlapping, an approach that may be termed sequential training.

In some approaches to linear filter design, the observation window size may be estimated to be between 5-7 times the number of coefficients. However, in the case of PIM cancellation, the observation window size used for PIMC was found to be at least approximately independent of the number of coefficients to be optimized. For example, a 3-tap FIR filter may use more than a subframe of an observation window, which may include 3×30720 samples.

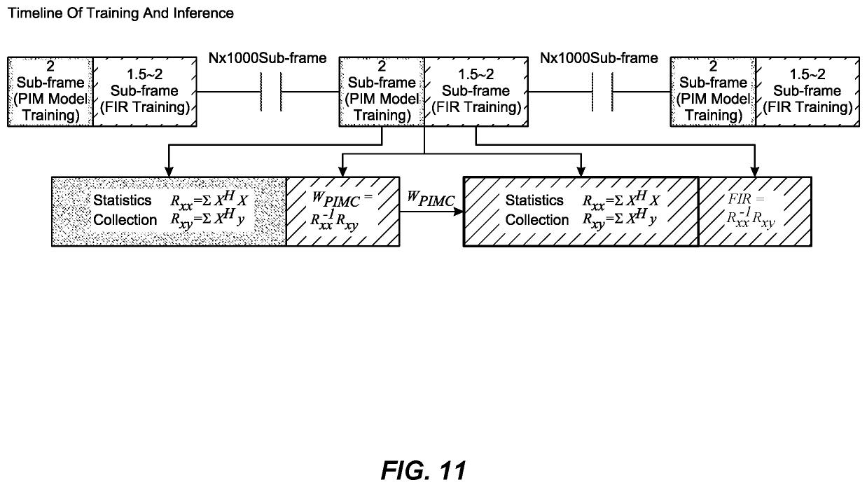

FIG. 11 shows an example timeline of training and inference. The timing requirements may be very relaxed, the timeline shown here is exemplary, and there is no need for strict sub-frame timeline. The time partition between statistics collection and matrix inversion is also relaxed, any suitable time partition may be used, and a low-cost approach may be used.

A robustness investigation of low-cost solutions evaluated the effects of the number of k-taps on PIM noise reduction. Surprisingly, the use of both odd and even taps gave excellent results, regardless of the PIM source with even-orders or odd-orders. Using odd-only or even-only taps gave reduced PIM noise reduction. For example, using k=[1,2,3,4,5] gave excellent noise reduction, which was better than using, for example, k=[1,3,5,7] and much better than using, for example, k=[2,4,6,8].

An example approach used the following settings: LaPIMsource=[0,1,2,3,4,5,6,7,8,9,10,11,12,13,14,15]; KaPIMsource=[2,4,6,8]; PIMC training window=1.5 ms; and FIR training window=1.5 ms. These data obtained using 3 FIR taps were comparable to an approach using 11 FIR taps.

In some aspects of PIM estimation, a low cost calculation of the sum of squares may use the alpha-max plus beta-min algorithm. Examples of this approach were found to give acceptable results for PIM noise estimation. However, for PIM model training, this approximate approach led to 1.5 dB degradation. An improved approximation was used for PIM model training, illustrated in Table 1 below:

TABLE 1
|z| = max(|z₀|, |z₁|),
|z₀| = α₀Max + β₀Min
|z₁| = α₁Max + β₁Min

| α₀ | β₀ | α₁ | β₁ | Largest Error (%) |
|---|---|---|---|---|
| 1 | 0 | 7/8 | 17/32 | −2.65% |
| 1 | 0 | 29/32 | 61/128 | +2.4 |
| 1 | 1/8 | 7/8 | 33/64 | −1.7% |
| 1 | 5/32 | 27/32 | 71/128 | 1.22% |
| 127/128 | 3/16 | 27/32 | 71/128 | −1.13% |

A PIM noise reduction of almost 20 dB was obtained using example PIMC approaches obtained using approaches such as those described above.

An evaluation of lead and lag terms was also performed. If the actual PIM noise includes lead and lag terms, and the model does not include lead and lag terms, then a slight degradation in model performance may be expected. The number of aligned terms, the number of led terms and the number of lag terms used in the model training depends on the PIM source complexity, which is highly related to the RF hardware (HW) design, material used, and manufacturing process, etc. Therefore, the number of aligned terms, the number of led terms and the number of lag terms used in the model training should be determined during design and turned as a part of the factory calibration process.

In other models, PIM lead terms in the PIM model may be used to suppress the effect of actual PIM lead terms, and PIM lag terms in the PIM model may be used to suppress the effect of actual PIM lag terms. These approaches were found to work well, and the number of taps used may be greater. The combination of a nonlinear model and a linear filter (e.g., an FIR filter) was found to give significant PIM noise reduction regardless of the PIM source complexity.

If the PIM model does not include an FIR filter, then increasing model complexity (e.g., by increasing the number of taps) increased the performance of the model. However, model performance was always significantly improved by including an FIR filter in the model.

When using an FIR filter, increasing the model complexity did not give appreciable benefits in model performance. Hence, the use of an FIR filter allows improved performance without the use of a more complex model, so that increasing model complexity is not necessary for improved model performance. Using an FIR filter, increased model complexity with PIMC lag terms and PIMC lead terms provided a dramatic increase in model complexity with very little return in terms of model improvement. In some examples, sequential training and cancellation to reduce matrix size may be used to reduce model complexity when the model includes lead and lag terms. In some examples, model complexity using lead and lag terms may be reduced by providing a model of the physical origins of the lead and lag terms. An FIR filter dramatically reduces model complexity and dramatically increases model performance.

Hence, with FIR, the increased complexity introduced by using PIMC-lag and PIMC-lead terms did not justify the computational investment, as there was a dramatic increase complexity with very little return in improvement.

It may be possible to obtain further increases in performances with small increase of complexity. For example, the underlying cause of PIM (e.g., a nonlinear component, contact corrosion, or the like) may be modeled using terms selected based on the underlying cause. These may be determined using experiments on test circuits having various degrees of nonlinearities. Sequential training and cancellation (e.g., of terms that do not lead to appreciable benefits) may be used to reduce matrix sizes.

Although some examples of PIM cancellation devices described herein may be implemented in hardware, in some examples, the PIM cancellation operations and/or methods described herein may be performed and/or executed via one or more software-implemented modules stored in memory and executed by one or more suitable physical processors.

FIG. 12 is a block diagram of an example system 1200 for multi-stage sequential PIM reduction via sequential training. As illustrated in this figure, example system 1200 may include one or more modules 1202 for performing one or more tasks. As will be explained in greater detail below, modules 1202 may include a determining module 1204 that determines a first stage estimated passive inter-modulation (PIM) noise using a nonlinear model (e.g., nonlinear model 1240). The nonlinear model may receive a nonlinear model input based on a transmitted signal.

As further shown in FIG. 12, example system 1200 may also include a nonlinear model training module 1206 that trains the nonlinear model using a training signal based on an uncorrected received signal. Example system 1200 may also include an estimating module 1208 that determines an estimated PIM noise using the first stage estimated PIM noise and a FIR filter (e.g., FIR filter 1250). As also shown in FIG. 12, example system 1200 may also include a FIR filter training module 1210 that trains the FIG filter using a second training signal based on the uncorrected received signal, and a filtering module 1212 that subtracts the estimated PIM noise from the uncorrected received signal.

As further illustrated in FIG. 12, example system 1200 may also include one or more memory devices, such as memory 1220. Memory 1220 generally represents any type or form of volatile or non-volatile storage device or medium capable of storing data and/or computer-readable instructions. In one example, memory 1220 may store, load, and/or maintain one or more of modules 1202. Examples of memory 1220 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 12, example system 1200 may also include one or more physical processors, such as physical processor 1230. Physical processor 1230 generally represents any type or form of hardware-implemented processing unit capable of interpreting and/or executing computer-readable instructions. In one example, physical processor 1230 may access and/or modify one or more of modules 1202 stored in memory 1220. Additionally or alternatively, physical processor 1230 may execute one or more of modules 1202 to facilitate multi-stage sequential PIM cancellation via sequential training. Examples of physical processor 1230 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also shown in FIG. 12, example system 1200 may also include a nonlinear model 1240 and a FIR filter 1250. Nonlinear model 1240 may include, represent, or be similar in function or attributes to, one or more of the nonlinear PIM models described herein, such as used in PIM model training module 308, PIM model training module 408, and so forth. Similarly, FIR filter 1250 may include, represent, and/or be similar in function or attributes to, one or more of the FIR filters described herein, such as FIR filter 306, FIR filter 406, and so forth.

Example system 1200 in FIG. 12 may be implemented in a variety of ways. For example, all or a portion of example system 1200 may represent portions of an example system 1300 (“system 1300”) in FIG. 13. As shown in FIG. 13, system 1300 may include a computing device 1302. In at least one example, computing device 1302 may be programmed with one or more of modules 1202.

In at least one embodiment, one or more modules 1202 from FIG. 12 may, when executed by computing device 1302, enable computing device 1302 to perform one or more operations for PIM cancellation via sequential training. For example, as will be described in greater detail below, determining module 1204 may determine a first stage estimated PIM noise 1304 using a nonlinear model (e.g., nonlinear model 1240). The nonlinear model may receive a nonlinear model input (e.g., nonlinear model input 1306) based on a transmitted signal (e.g., transmitted signal 1308).

Additionally, nonlinear model training module 1206 may train the nonlinear model using a training signal (e.g., training signal 1310) based on an uncorrected received signal (e.g., uncorrected received signal 1312). Furthermore, estimating module 1208 may determine an estimated PIM noise (e.g., estimated PIM noise 1314) using the first stage estimated PIM noise and a FIR filter (e.g., FIR filter 1250).

Moreover, FIR filter training module 1210, may train the FIR filter using a second training signal (e.g., second training signal 1316) based on the uncorrected received signal, and filtering module 1212, may subtract the estimated PIM noise from the uncorrected received signal.

In some examples, nonlinear model training module 1206 may train the nonlinear model and the FIR filter training module may train the FIR filter as sequential training steps. In additional examples, nonlinear model training module 1206 may train the nonlinear model and the FIR filter training module may train the FIR as independent training steps.

Computing device 1302 generally represents any type or form of computing device capable of reading and/or executing computer-executable instructions and/or hosting executables. Examples of computing device 1302 include, without limitation, application servers, storage servers, database servers, web servers, and/or any other suitable computing device configured to run certain software applications and/or provide various application, storage, and/or database services.

In at least one example, computing device 1302 may be a computing device programmed with one or more of modules 1202. All or a portion of the functionality of modules 1202 may be performed by computing device 1302 and/or any other suitable computing system. As will be described in greater detail below, one or more of modules 1202 from FIG. 12 may, when executed by at least one processor of computing device 1302, may enable computing device 1302 to perform multi-stage sequential PIM cancellation via sequential training.

Many other devices or subsystems may be connected to system 1200 in FIG. 12 and/or system 1300 in FIG. 13. Conversely, all of the components and devices illustrated in FIGS. 12 and 13 need not be present to practice the embodiments described and/or illustrated herein. The devices and subsystems referenced above may also be interconnected in different ways from those shown in FIG. 13. System 1200 and system 1300 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

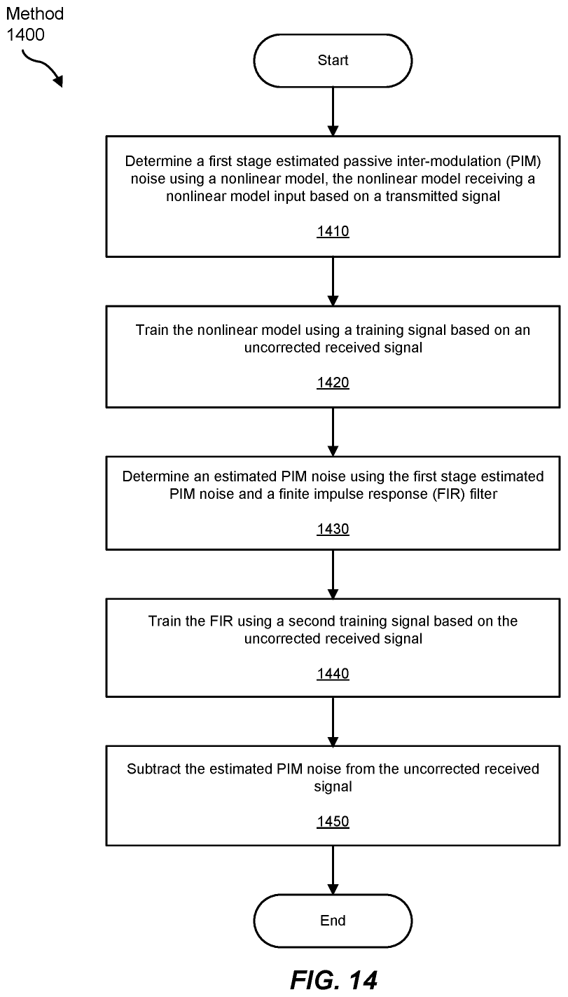

FIG. 14 is a flow diagram of an example method 1400 for multi-stage sequential PIM cancellation via sequential training. The steps shown in FIG. 14 may be performed by any suitable device, computer-executable code, and/or computing system, including PIM cancellation device 116 in FIG. 1, PIM cancellation device 302 in FIG. 3, PIM cancellation device 402 in FIG. 4, system 1200 in FIG. 12, system 1300 in FIG. 13, and/or variations or combinations of one or more of the same. In one example, each of the steps shown in FIG. 14 may represent an algorithm whose structure includes and/or is represented by multiple sub-steps, examples of which are be provided in greater detail herein.

As illustrated in FIG. 14, at step 1410, one or more of the devices and/or systems described herein may determine a first stage estimated PIM noise using a nonlinear model, the nonlinear model receiving a nonlinear model input based on a transmitted signal. For example, determining module 1204 may, as part of computing device 1302, cause computing device 1302 to determine a first stage estimated PIM noise 1304 using nonlinear model 1240. Nonlinear model 1240 may receive nonlinear model input 1306 based on a transmitted signal 1308. Determining module 1204 may perform these operations in any of the ways described herein.

At step 1420, one or more of the devices and/or systems described herein may train the nonlinear model using a training signal based on an uncorrected received signal. For example, nonlinear model training module 1206 may, as part of computing device 1302, cause computing device 1302 to train nonlinear model 1240 using a training signal 1310 based on an uncorrected received signal 1312. Nonlinear model training module 1206 may perform these operations in any of the ways described herein.

At step 1430, one or more of the devices and/or systems described herein may determine an estimated PIM noise using the first stage estimated PIM noise and a FIR filter. For example, estimating module 1208 may, as part of computing device 1302, cause computing device 1302 to determine an estimated PIM noise 1314 using the first stage estimated PIM noise and FIR filter 1250. Estimating module 1208 may perform these operations in any of the ways described herein.

At step 1440, one or more of the devices and/or systems described herein may train the FIR using a second training signal based on the uncorrected received signal. For example, FIR filter training module 1210 may, as part of computing device 1302, cause computing device 1302 to train FIR filter 1250 using second training signal 1316 based on uncorrected received signal 1312. FIR filter training module 1210 may perform these operations in any of the ways described herein.

At step 1450, one or more of the devices and/or systems described herein may subtract the estimated PIM noise from the uncorrected received signal. For example, subtracting module 1212 may, as part of computing device 1302, cause computing device 1302 to subtract estimated PIM noise 1314 from uncorrected received signal 1312. Subtracting module 1212 may perform these operations in any of the ways described herein.

As described throughout the instant disclosure, the devices, systems, and methods described herein may provide significant advantages over conventional options for handling passive inter-modulation noise. Examples may include approaches and architectures for PIMC, for example, to reduce noise in a received RF signal, such as a received signal at a cellular phone base-station. PIM noise may be an interference signal in the received signal received over the uplink receiver RF HW chain due to the transmission of a radio signal on the downlink transmitter RF HW chain. PIM noise may arise, at least in part, from nonlinear behavior in the RF transmission circuitry and/or a duplexer that may couple the transmission circuitry and the receiver circuitry. PIM interference, sometimes referred to herein as PIM noise, in the received signal may reduce the receiver sensitivity and may block receiving uplink traffic.

As discussed further above, PIM noise may arise from nonlinear junctions due to nonlinear current-voltage behavior. Example sources of PIM noise may include one or more of the following: metal-metal contact surfaces separated by a thin oxide (e.g., MIM diode behavior), rough metal-metal contact surfaces that cause current crowding at spots where conduction is both resistive and capacitive, nonlinear materials, or impure materials. The source of the nonlinearity can be randomly distributed over the transmission path and its environment. The nonlinearity may change over time due to changes in temperature, moisture (e.g., humidity), a bird on transmission line or antenna panel, or any other reason. Approaches to stabilizing the nonlinear model coefficients described herein may help reduce the effects of transient changes in nonlinearities or other noise sources.

In some examples, PIM distortion may arise due to interactions between two or more carrier channels. In a base station where multi-carrier and multi-band are used, many transmitted signals may become mixed with each other and PIM distortion may spread over a wide range of the spectrum and reach one or more receiver bands. Besides PIM distortion created by internal transmitted signals, the external transmitted signals from the neighbor cells may be present as a PIM source and interfere a particular receiver bands. A nonlinear model may be adapted to these or other possible configurations.

Example approaches to reduce PIM noise may include the use of adaptive filters to estimate PIM and subtract the estimated PIM distortion from an uncorrected received signal to provide a PIM-cancelled received signal.

Examples provided herein include devices, apparatuses, systems, and methods related to using the transmitted downlink signal to determine an estimated PIM in the received signal, and subtracting the estimated PIM from the received signal to obtain a PIM cancelled received signal. The received signal may include PIM noise, and by subtracting an estimate of the PIM noise from the received signal the receiver sensitivity may be improved.

Examples include multiple-stage sequential PIM cancellation system using a sequential training approach, including apparatus and associated methods. The system may include a nonlinear filter that takes the transmitted signal as input and the output of the first stage nonlinear filter is the input of the second stage. The second stage may include a second filter, such as a linear FIR (finite response filter) that takes the output of the first stage as its input, and the output of the second stage is an estimated PIM in the received uncorrected signal, which may include a combination of the desired received signal and PIM noise. The PIM cancelled signal (the PIMC result) is obtained by subtracting the estimated PIM noise from the uncorrected received signal to remove the actual PIM noise from a corrected received signal, so that the corrected received signal includes the desired received signal without appreciable PIM noise.

Example systems, apparatus or methods may include one or more of the following features. The training of the first stage nonlinear filter and the training of the second stage linear FIR filter may be independent and sequential, not a joint optimization, each with a goal that its own output minimizes the error energy between the output and the received signal. The nonlinear filter may include both even order and odd order of the products of its input (the transmitted signal) regardless of the PIM structure. The linear FIR filter may include a 3-tap FIR filter, regardless of the PIM structure. Examples include a passive intermodulation (PIM) cancellation system. The system may include a multi-stage trained model for improving receiver sensitivity of a radio signal. A PIM cancellation system may include a nonlinear filter that uses a transmitted downlink signal as an input, and a linear filter (e.g., a finite response filter or FIR) that uses the output of the nonlinear filter as its input. The system may estimate the PIM noise within the uncorrected received signal, which includes the desired received signal and the PIM noise (sometimes termed PIM interference). The estimated PIM may be subtracted from the uncorrected received signal to provide a PIMC (PIM cancelled) received signal, which may also be termed a corrected signal. An example system may perform sequential training of the nonlinear filter and the linear filter (e.g., not a joint optimization algorithm). The nonlinear filter may include the even order and the odd order products of its input (e.g., based on the transmitted signal). The linear filter may be or include a multi-tap FIR filter, such as a 3-tap FIR filter.

In conclusion, nonlinearities in a cellphone base station transmitter may lead to transmitted frequency components spilling over into nearby receiver bands, creating passive PIM noise in the receiver signal. In some examples, PIM noise may be estimated using a trained model, for example, the PIM noise may be estimated based on the transmitted signal. The estimated PIM noise may then be subtracted from the receiver signal to cancel the actual PIM noise in the receiver signal. Example approaches may use a nonlinear PIM estimation model followed by a linear filter (e.g., a finite response filter). The estimation model may include both odd and even power terms, even if both are not expected in the PIM noise signal. The PIM estimation model and linear filter may each be trained at intervals within a period of approximately 1 millisecond during operation of the base station while the old model or filter is still in use. Model stability may be improved by including a contribution from previous model parameters into the new model parameters. Simulated results showed excellent noise reduction.

The following example embodiments are also included in this disclosure:

Example 1: A method of reducing passive inter-modulation (PIM) noise in a received signal, the method comprising (1) determining a first stage estimated passive inter-modulation (PIM) noise using a nonlinear model, the nonlinear model receiving a nonlinear model input based on a transmitted signal, (2) training the nonlinear model using a training signal based on an uncorrected received signal, (3) determining an estimated PIM noise using the first stage estimated PIM noise and a finite impulse response (FIR) filter, (4) training the FIR using a second training signal based on the uncorrected received signal, and (5) subtracting the estimated PIM noise from the uncorrected received signal.

Example 2: The method of example 1, wherein the training of the nonlinear model and the training of the FIR filter are sequential training steps.

Example 3: The method of any of examples 1-2, wherein the training of the nonlinear model and the training of the FIR are independent training steps.

Example 4: The method of any of examples 1-3, wherein the nonlinear model comprises both even order and odd order product terms based on the nonlinear model input.

Example 5: The method of any of examples 1-4, wherein the FIR filter is a three-tap FIR filter.

Example 6: The method of example any of examples 1-5, wherein (1) The method of claim 1, wherein training the nonlinear model further comprises (A) collecting a first statistics collection for nonlinear model training, and (B) updating the nonlinear model based on the nonlinear model training, and (2) training the FIR filter further comprises (A) collecting a second statistics collection for FIR filter training, and (B) updating the FIR filter updating based on the FIR filter training.

Example 7: The method of example 6, wherein the FIR filter is used to determine the estimated PIM noise during the FIR filter training.

Example 8: The method of any of examples 1-7, wherein subtracting the estimated PIM noise from the uncorrected received signal reduces PIM noise in the uncorrected received signal by at least 16 decibels.

Example 9: A system comprising (1) a determining module, stored in memory, that determines a first stage estimated passive inter-modulation (PIM) noise using a nonlinear model, the nonlinear model receiving a nonlinear model input based on a transmitted signal, (2) a nonlinear model training module, stored in memory, that trains the nonlinear model using a training signal based on an uncorrected received signal, (3) an estimating module, stored in memory, that determines an estimated PIM noise using the first stage estimated PIM noise and a finite impulse response (FIR) filter, (4) a FIR filter training module, stored in memory, that trains the FIR filter using a second training signal based on the uncorrected received signal, (5) a filtering module, stored in memory, that subtracts the estimated PIM noise from the uncorrected received signal, and (6) at least one physical processor that executes the determining module, the nonlinear model training module, the estimating module, the FIR training module, and the filtering module.

Example 10: The system of example 9, wherein the nonlinear model training module trains the nonlinear model and the FIR filter training module trains the FIR filter as sequential training steps.

Example 11: The system of any of examples 9-10, wherein the nonlinear model training module trains the nonlinear model and the FIR filter training module trains the FIR as independent training steps.

Example 12: The system of any of examples 9-11, wherein the nonlinear model comprises both even order and odd order product terms based on the nonlinear model input.

Example 13: The system of examples 9-12, wherein the FIR filter comprises a three-tap FIR filter.

Example 14: The system of examples 9-13, wherein (1) the nonlinear model training module trains the nonlinear model by (A) collecting a first statistics collection for nonlinear model training, and (B) updating the nonlinear model based on the nonlinear model training, and (2) the FIR training module further trains the FIR filter by (A) collecting a second statistics collection for FIR filter training, and (B) updating the FIR filter updating based on the FIR filter training.

Example 15: The system of examples 9-14, wherein the determining module uses the FIR filter to determine the estimated PIM noise during the FIR filter training.

Example 16: The system of examples 9-15, wherein subtracting the estimated PIM noise from the uncorrected received signal reduces the PIM noise in the uncorrected received signal by at least 16 decibels.

Example 17: A system comprising (1) a radio frequency (RF) transmitter, (2) an RF receiver, and (3) a passive inter-modulation (PIM) noise reduction device comprising (A) a PIM noise estimator including a nonlinear model, the PIM noise estimator configured to receive a nonlinear model input signal based on a transmitted signal and output a first stage PIM noise signal, (B) an FIR filter configured to receive the first stage PIM noise signal and output an estimated PIM noise signal, (C) a subtractor configured to receive an uncorrected received signal and subtract the estimated PIM noise signal from the uncorrected received signal to provide a PIM-cancelled received signal, (D) a nonlinear model trainer configured to receive the nonlinear model input signal and a training signal based on the uncorrected received signal, and (E) an FIR filter trainer configured to receive the first stage PIM signal and a second training signal based on the uncorrected received signal.

Example 18: The system of example 17, wherein the PIM noise reduction device is configured to (1) receive the nonlinear model input signal, (2) receive the uncorrected received signal, and (3) output the PIM-cancelled received signal.

Example 19: The system of any of examples 17-18, wherein the RF transmitter is configured to (1) modulate an RF carrier frequency using the transmitted signal to (2) provide an RF modulated signal, (3) amplify the RF modulated signal to provide an RF transmitted signal, and (4) provide the RF transmitted signal to an antenna.

Example 20: The system of example 17-19, wherein the RF receiver is configured to (1) receive an RF modulated received signal, and (2) demodulate the RF modulated received signal to provide the uncorrected received signal.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive signal data to be transformed, transform the signal data (e.g., using up-sampling, down-sampling, modulation, demodulation, mixing or any form of linear or nonlinear combination), output a result of the transformation to perform a function (e.g., to cancel a noise component, update a model, and the like), use the result of the transformation to perform a function (e.g., to cancel a noise component, update a model, and the like), and store the result of the transformation to perform a function (such as updated model coefficients). Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method of reducing passive inter-modulation (PIM) noise in a received signal, the method comprising:
determining a first stage estimated passive inter-modulation (PIM) noise using a nonlinear model, the nonlinear model receiving a nonlinear model input based on a transmitted signal;
training the nonlinear model using a training signal based on an uncorrected received signal;
determining an estimated PIM noise using the first stage estimated PIM noise and a finite impulse response (FIR) filter;
training the FIR filter using a second training signal based on the uncorrected received signal; and
subtracting the estimated PIM noise from the uncorrected received signal.

2. The method of claim 1, wherein the training of the nonlinear model and the training of the FIR filter are sequential training steps.

3. The method of claim 1, wherein the training of the nonlinear model and the training of the FIR filter are independent training steps.

4. The method of claim 1, wherein the nonlinear model comprises both even order and odd order product terms based on the nonlinear model input.

5. The method of claim 1, wherein the FIR filter is a three-tap FIR filter.

6. The method of claim 1, wherein:
training the nonlinear model further comprises:
collecting a first statistics collection for nonlinear model training; and
updating the nonlinear model based on the nonlinear model training; and
training the FIR filter further comprises:
collecting a second statistics collection for FIR filter training; and
updating the FIR filter updating based on the FIR filter training.

7. The method of claim 6, wherein the FIR filter is used to determine the estimated PIM noise during the FIR filter training.

8. The method of claim 1, wherein subtracting the estimated PIM noise from the uncorrected received signal reduces PIM noise in the uncorrected received signal by at least 16 decibels.

9. A system comprising:
a determining module, stored in memory, that determines a first stage estimated passive inter-modulation (PIM) noise using a nonlinear model, the nonlinear model receiving a nonlinear model input based on a transmitted signal;
a nonlinear model training module, stored in memory, that trains the nonlinear model using a training signal based on an uncorrected received signal;
an estimating module, stored in memory, that determines an estimated PIM noise using the first stage estimated PIM noise and a finite impulse response (FIR) filter;
a FIR filter training module, stored in memory, that trains the FIR filter using a second training signal based on the uncorrected received signal;
a filtering module, stored in memory, that subtracts the estimated PIM noise from the uncorrected received signal; and
at least one physical processor that executes the determining module, the nonlinear model training module, the estimating module, the FIR training module, and the filtering module.

10. The system of claim 9, wherein the nonlinear model training module trains the nonlinear model and the FIR filter training module trains the FIR filter as sequential training steps.

11. The system of claim 9, wherein the nonlinear model training module trains the nonlinear model and the FIR filter training module trains the FIR filter as independent training steps.

12. The system of claim 9, wherein the nonlinear model comprises both even order and odd order product terms based on the nonlinear model input.

13. The system of claim 9, wherein the FIR filter comprises a three-tap FIR filter.

14. The system of claim 9, wherein:
the nonlinear model training module further trains the nonlinear model by:
collecting a first statistics collection for nonlinear model training; and
updating the nonlinear model based on the nonlinear model training; and
the FIR training module further trains the FIR filter by:
collecting a second statistics collection for FIR filter training; and
updating the FIR filter updating based on the FIR filter training.

15. The system of claim 9, wherein the determining module uses the FIR filter to determine the estimated PIM noise during the FIR filter training.

16. The system of claim 9, wherein subtracting the estimated PIM noise from the uncorrected received signal reduces the PIM noise in the uncorrected received signal by at least 16 decibels.

17. A system comprising:
a radio frequency (RF) transmitter;
an RF receiver; and
a passive inter-modulation (PIM) noise reduction device comprising:
a PIM noise estimator including a nonlinear model, the PIM noise estimator configured to receive a nonlinear model input signal based on a transmitted signal and output a first stage PIM noise signal;
an FIR filter configured to receive the first stage PIM noise signal and output an estimated PIM noise signal;
a subtractor configured to receive an uncorrected received signal and subtract the estimated PIM noise signal from the uncorrected received signal to provide a PIM-cancelled received signal;
a nonlinear model trainer configured to receive the nonlinear model input signal and a training signal based on the uncorrected received signal; and
an FIR filter trainer configured to receive the first stage PIM signal and a second training signal based on the uncorrected received signal.

18. The system of claim 17, wherein the PIM noise reduction device is configured to:
receive the nonlinear model input signal;
receive the uncorrected received signal; and
output the PIM-cancelled received signal.

19. The system of claim 17, wherein the RF transmitter is configured to:
modulate an RF carrier frequency using the transmitted signal to provide an RF modulated signal;
amplify the RF modulated signal to provide an RF transmitted signal; and
provide the RF transmitted signal to an antenna.

20. The system of claim 17, wherein the RF receiver is configured to:
receive an RF modulated received signal; and
demodulate the RF modulated received signal to provide the uncorrected received signal.
